(19) United States
(12) Patent Application Publication
(10) Pub. No.: US 2026/0021996 A1
(43) Pub. Date: Jan. 22, 2026

(54) HANDRAIL TENSIONING DEVICE AND ESCALATOR INSTALLATION MODULE COMPRISING THE SAME

(71) Applicant: KONE Corporation, Helsinki (FI)

(72) Inventors: Bingxi Xiao, Kunshan (CN); Haifeng Dai, Kunshan (CN); Weiwei Zhao, Kunshan (CN); Jiesong Jiang, Kunshan (CN)

(73) Assignee: KONE Corporation, Helsinki (FI)

(21) Appl. No.: 19/274,315

(22) Filed: Jul. 18, 2025

(30) Foreign Application Priority Data
Jul. 19, 2024 (CN) 202421724798.X

(51) Int. Cl. B66B 23/20

(52) U.S. Cl. CPC B66B 23/20

(57) ABSTRACT

At least one embodiment of the present disclosure provides a handrail tensioning device and an escalator installation module comprising the same. The handrail tensioning device includes: a mounting bracket having a mounting foot for fixing to a module bracket of the escalator installation module; a connecting bracket connected to the mounting bracket; a pressure wheel mounted to the connecting bracket; and an adjusting bolt configured to be screwed so that the connecting bracket moves relative to the mounting bracket in a vertical direction. The adjusting head of the adjusting bolt and the mounting foot of the mounting bracket are provided at opposite ends of the handrail tensioning device in the vertical direction. Since the handrail tensioning device is fixed to the module bracket of the escalator installation module via the mounting foot of the mounting bracket, complex adjustment steps for the handrail tensioning device are eliminated. Additionally, because the adjusting head is positioned away from the mounting foot, it can be located in a position easily accessible to maintenance personnel.

### TECHNICAL FIELD

The present disclosure relates to a handrail tensioning device and an escalator installation module.

### BACKGROUND

The handrail tensioning device is used to adjust the tension level of an annular handrail belt to adapt it to specific dimensions of an escalator. Conventional handrail tensioning devices are directly fixed to a truss of the escalator, requiring assembly and maintenance personnel to perform complex adjustment work, thereby increasing installation time and costs. Furthermore, in modernization scenarios for existing escalators, the installation interface of the handrail tensioning device cannot adapt to all existing escalator trusses. Additionally, after the escalator is installed, adjusting the handrail tensioning device becomes difficult, as it requires removing steps to access the adjustment interface of the tensioning device, which is inconvenient for repair and maintenance.

### SUMMARY

At least one embodiment of the present disclosure provides a handrail tensioning device, comprising: a mounting bracket having a mounting foot for fixing to a module bracket of an escalator installation module; a connecting bracket connected to the mounting bracket; a pressure wheel mounted to the connecting bracket; and an adjusting bolt configured to be screwed so that the connecting bracket moves relative to the mounting bracket in a vertical direction. An adjusting head of the adjusting bolt and the mounting foot of the mounting bracket are provided at opposite ends of the handrail tensioning device in the vertical direction.

For example, in some embodiments, the mounting bracket comprises a mounting bracket body and a nut block fixed to the mounting bracket body. The connecting bracket comprises a plate-shaped body, a lug fixed to the plate-shaped body, and a guide groove provided in the plate-shaped body. The handrail tensioning device further comprises a sliding guide fixed to the mounting bracket, wherein the sliding guide cooperates with the guide groove to guide the movement of the connecting bracket relative to the mounting bracket in the vertical direction. The adjusting bolt passes through an opening provided in the lug of the connecting bracket in the vertical direction and is threaded into the nut block.

For example, in some embodiments, the adjusting bolt is configured to be rotatable relative to the lug but not translatable, and an end side of the adjusting head of the adjusting bolt abuts against the lug.

For example, in some embodiments, the mounting bracket body comprises a transverse plate and a mounting leg extending from the transverse plate away from the adjusting head of the adjusting bolt, and the mounting foot is provided at an end of the mounting leg away from the adjusting head of the adjusting bolt.

For example, in some embodiments, the adjusting head of the adjusting bolt and the pressure wheel are provided at opposite ends of the connecting bracket in the vertical direction.

At least one embodiment of the present disclosure further provides an escalator installation module, comprising: the module bracket, which is used to be installed to a truss of the escalator; and the handrail tensioning device as described above.

For example, in some embodiments, the escalator installation module further comprises: a skirt plate and a cover plate, wherein the skirt plate and the cover plate are provided on both sides of steps of the escalator. The handrail tensioning device is provided on a side of the skirt plate away from the steps, and is provided below the cover plate, and the cover plate is directly adjacent to the adjusting head of the adjusting bolt.

For example, in some embodiments, the module bracket comprises an upper module bracket and a lower module bracket, and the mounting bracket is fixed to a curved portion of the lower module bracket.

### BRIEF DESCRIPTION OF THE DRAWINGS

To more clearly illustrate the technical solutions of the embodiments of the present disclosure, the following briefly introduces the accompanying drawings required for describing the embodiments. It should be understood that the following drawings show only certain embodiments of the present disclosure and therefore should not be considered as limiting the scope. For those of ordinary skill in the art, other related drawings may be obtained from these drawings without creative efforts.

FIG. 1 shows a perspective view of an escalator installation module according to an embodiment of the present disclosure;

FIG. 2 shows a perspective view of a handrail tensioning device according to an embodiment of the present disclosure;

FIG. 3 shows another perspective view of the handrail tensioning device according to an embodiment of the present disclosure, wherein the mounting bracket is not shown; and

FIG. 4 shows a partial perspective view of an escalator equipped with the handrail tensioning device according to an embodiment of the present disclosure, wherein the cover plate is removed to reveal a portion of the handrail tensioning device.

### DETAILED DESCRIPTION

Hereinafter, the handrail tensioning device and escalator installation module according to embodiments of the present disclosure will be described in detail with reference to the accompanying drawings. To make the objectives, technical solutions, and advantages of the present disclosure clearer, the technical solutions in the embodiments of the present disclosure will be described clearly and comprehensively in conjunction with the drawings. Obviously, the described embodiments represent only a part of the embodiments of the present disclosure, rather than all of them.

Therefore, the following detailed description of the embodiments of the present disclosure provided in conjunction with the drawings is not intended to limit the scope of the claimed disclosure but merely represents selected embodiments of the present disclosure. Based on the embodiments of the present disclosure, all other embodiments obtained by those of ordinary skill in the art without creative efforts shall fall within the protection scope of the present disclosure.

Unless otherwise defined in the context, singular forms include plural forms. Throughout the description, terms such as “comprise”, “include”, “have”, etc., are used to specify the presence of stated features, numbers, steps, operations, elements, components, or combinations thereof, but do not preclude the presence or addition of one or more other features, numbers, steps, operations, elements, components, or combinations thereof.

Additionally, even if ordinal terms such as “first”, “second”, etc., are used to describe various components, these components are not limited by such terms. These terms are only used to distinguish one element from another.

Furthermore, in the description of the present disclosure, it should be understood that directional or positional relationships indicated by terms such as “upper”, “lower”, “left”, “right”, “front”, “rear”, etc., are based on the orientations or positional relationships shown in the drawings, the customary placement of the disclosed product during use, or the orientations or positional relationships commonly understood by those skilled in the art. These terms are used merely for convenience in describing the present disclosure and simplifying the description, and do not indicate or imply that the referenced devices or elements must have specific orientations or be constructed and operated in specific orientations. Thus, they should not be construed as limiting the present disclosure.

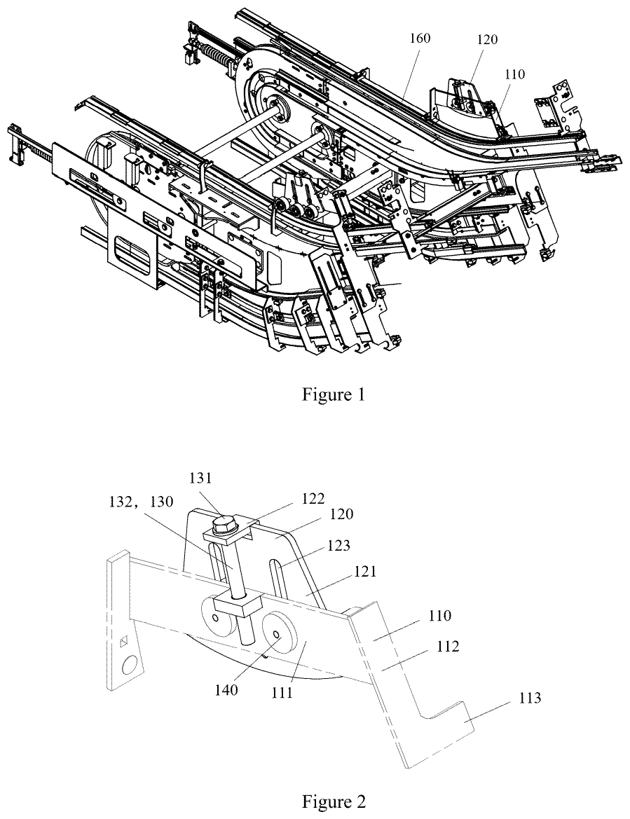

FIG. 1 shows a perspective view of an escalator installation module according to an embodiment of the present disclosure. As shown in FIG. 1, the escalator installation module includes a module bracket configured to be mounted to a truss (not shown) of an escalator. The truss of the escalator is a bracket embedded in the building. During modernization of existing escalators, the truss of the existing escalator is typically retained while the escalator installation module is provided for replacement and modernization purposes. The module bracket includes an upper module bracket (not shown) located at an upper portion of the escalator and a lower module bracket 160 positioned at a lower portion of the escalator. Only the lower module bracket 160 is shown in FIG. 1.

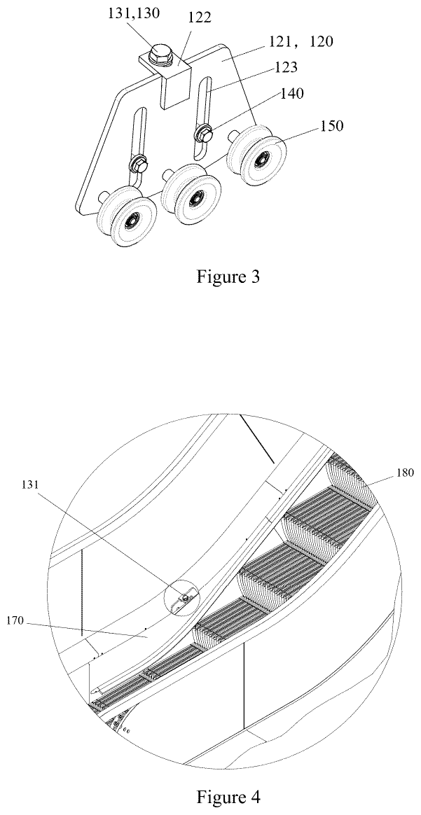

FIG. 2 shows a perspective view of a handrail tensioning device according to an embodiment of the present disclosure, and FIG. 3 shows another perspective view of the handrail tensioning device according to an embodiment of the present disclosure.

As shown in FIGS. 1-3, the handrail tensioning device includes a mounting bracket 110, a connecting bracket 120, a pressure wheel 150, an adjusting bolt 130, and a sliding guide 140. In the embodiments of the present disclosure, the handrail tensioning device is fixed to the module bracket through the mounting bracket 110 (i.e., the mounting interface), rather than being directly fixed to the truss. The position of the handrail tensioning device is fixed relative to other functional components such as drive units and skirt panels 170 that are also mounted to the module bracket. Therefore, the handrail tensioning device does not require adaptive modifications or adjustments to accommodate the dimensions and structure of the existing escalator's truss, and can directly coordinate well with these functional components, thereby saving installation time and costs.

As shown in FIGS. 2 and 3, the mounting bracket 110 includes a mounting bracket body and a nut block fixed to the mounting bracket body. The mounting bracket body includes a transverse plate 111 and a mounting leg 112 extending from the transverse plate 111, with a mounting foot 113 located at the free end of the mounting leg 112. In this embodiment, as shown in FIG. 1, the mounting bracket 110 is fixed at the mounting foot 113 to the curved portion of the lower module bracket 160. The connecting bracket 120 is connected to the mounting bracket 110 such that the connecting bracket 120 is movable relative to the mounting bracket 110 in the vertical direction. The pressure wheel 150 is mounted to the connecting bracket 120 to move together with the connecting bracket 120 in the vertical direction. The pressure wheel 150 is configured to engage with the handrail belt to adjust the tension force of the handrail belt.

The connecting bracket 120 includes a plate-shaped body 121, an L-shaped lug 122 fixed to the plate-shaped body 121, and a guide groove 123 provided in the plate-shaped body 121. The sliding guide 140 engages with the guide groove 123 to guide the movement of the connecting bracket 120 relative to the mounting bracket 110 in the vertical direction. For instance, the sliding guide 140 comprises a bolt fixed to the mounting bracket body, which extends through the guide groove 123. Thus, the connecting bracket 120 is able to move smoothly in the vertical direction relative to the mounting bracket 110. The adjusting bolt 130 has an adjusting head 131 and a shank 132. By operating the adjusting head 131 of the adjusting bolt 130 to rotate the adjusting bolt 130, the connecting bracket 120 is moved in the vertical direction relative to the mounting bracket 110. In the present embodiment, the shank 132 of the adjusting bolt 130 passes through the opening in the lug 122 and is threaded into the nut block. One end side of the adjusting head 131 abuts against the lug 122 at one side of the lug 122. The other side of the lug 122 is provided with a stopper, such that the adjusting bolt 130 is rotatable relative to the lug 122 but cannot translate. The adjusting bolt 130, the connecting bracket 120, and the mounting bracket 110 may also have other configurations, and the present disclosure is not limited thereto.

In the embodiments of the present disclosure, the adjusting head 131 of the adjusting bolt 130 and the mounting foot 113 of the mounting bracket 110 are provided at opposite ends of the handrail tensioning device in the vertical direction. The mounting leg 112 extends away from the adjusting head 131, and the mounting foot 113 is provided at one end of the mounting leg 112 away from the adjusting head 131. The adjusting head 131 of the adjusting bolt 130 and the pressure wheel 150 are provided at opposite ends of the connecting bracket 120 in the vertical direction. Therefore, when the handrail tensioning device is mounted to the module bracket via the mounting foot 113, the adjusting head 131 can extend vertically upward to a position accessible to maintenance personnel.

FIG. 4 shows a partial perspective view of an escalator equipped with the handrail tensioning device according to an embodiment of the present disclosure, where the cover plate is removed to reveal a portion of the handrail tensioning device. As shown in FIG. 4, the side skirt plate 170 and the upper cover plate are provided on both sides of the steps 180 of the escalator. The handrail tensioning device is provided on the side of the skirt plate 170 away from the steps 180 and is positioned below the cover plate. The adjusting head 131 extends vertically upward to a position directly adjacent to the cover plate. That is, there are no other components between the adjusting head 131 and the cover plate. Therefore, after removing the cover plate, the tension level of the handrail belt can be adjusted by operating the adjusting head 131 of the adjusting bolt 130 without the need to disassemble the steps 180 or other components. Thus, maintenance of the escalator becomes simpler and more convenient.

The scope of the present disclosure is not limited by the described embodiments but is defined by the appended claims and their equivalents.

1. A handrail tensioning device, characterized in that it comprises:
a mounting bracket having a mounting foot for fixing to a module bracket of an escalator mounting module;
a connecting bracket connected to the mounting bracket;
a pressure wheel mounted to the connecting bracket; and
an adjusting bolt configured to be screwed so that the connecting bracket moves relative to the mounting bracket in a vertical direction, wherein
an adjusting head of the adjusting bolt and the mounting foot of the mounting bracket are provided at opposite ends of the handrail tensioning device in a vertical direction.

2. The handrail tensioning device according to claim 1, characterized in that,
the mounting bracket comprises a mounting bracket body and a nut block fixed to the mounting bracket body,
the connecting bracket comprises a plate-shaped body, a lug fixed to the plate-shaped body, and a guide groove provided in the plate-shaped body,
the handrail tensioning device further comprises a sliding guide fixed to the mounting bracket, the sliding guide cooperates with the guide groove to guide the movement of the connecting bracket relative to the mounting bracket in the vertical direction,
the adjusting bolt passes through an opening provided in the lug of the connecting bracket in the vertical direction and is threaded into the nut block.

3. The handrail tensioning device according to claim 2, characterized in that,
the adjusting bolt is configured to be rotatable relative to the lug but not translatable,
an end side of the adjusting head of the adjusting bolt abuts against the lug.

4. The handrail tensioning device according to claim 1, characterized in that,
the mounting bracket body comprises a transverse plate and a mounting leg extending from the transverse plate away from the adjusting head of the adjusting bolt, and the mounting foot is provided at an end of the mounting leg away from the adjusting head of the adjusting bolt.

5. The handrail tensioning device according to claim 1, characterized in that,
the adjusting head of the adjusting bolt and the pressure wheel are provided at opposite ends of the connecting bracket in the vertical direction.

6. An escalator installation module, characterized in that it comprises:
the module bracket, which is used to be installed to a truss of the escalator; and
the handrail tensioning device according to claim 1.

7. The escalator installation module according to claim 6, characterized in that it also comprises:
a skirt plate and a cover plate, the skirt plate and the cover plate being provided on both sides of steps of the escalator,
the handrail tensioning device is provided on a side of the skirt plate away from the steps, and is provided below the cover plate, and the cover plate is directly adjacent to the adjusting head of the adjusting bolt.

8. The escalator installation module according to claim 6, characterized in that,
the module bracket comprises an upper module bracket and a lower module bracket, and
the installation bracket is fixed to a curved portion of the lower module bracket.

9. The handrail tensioning device according to claim 2, characterized in that,
the adjusting head of the adjusting bolt and the pressure wheel are provided at opposite ends of the connecting bracket in the vertical direction.

10. The handrail tensioning device according to claim 3, characterized in that,
the adjusting head of the adjusting bolt and the pressure wheel are provided at opposite ends of the connecting bracket in the vertical direction.

11. The handrail tensioning device according to claim 4, characterized in that,
the adjusting head of the adjusting bolt and the pressure wheel are provided at opposite ends of the connecting bracket in the vertical direction.

12. An escalator installation module, characterized in that it comprises:
the module bracket, which is used to be installed to a truss of the escalator; and
the handrail tensioning device according to claim 2.

13. An escalator installation module, characterized in that it comprises:
the module bracket, which is used to be installed to a truss of the escalator; and
the handrail tensioning device according to claim 3.

14. An escalator installation module, characterized in that it comprises:
the module bracket, which is used to be installed to a truss of the escalator; and
the handrail tensioning device according to claim 4.

15. An escalator installation module, characterized in that it comprises:
the module bracket, which is used to be installed to a truss of the escalator; and
the handrail tensioning device according to claim 5.

16. The escalator installation module according to claim 7, characterized in that,
the module bracket comprises an upper module bracket and a lower module bracket, and
the installation bracket is fixed to a curved portion of the lower module bracket.
